(19) United States
(12) Patent Application Publication
(10) Pub. No.: US 2015/0044535 A1
(43) Pub. Date: Feb. 12, 2015

(54) LITHIUM SECONDARY BATTERY

(71) Applicant: SANYO Electric Co., Ltd., Moriguchi-city, Osaka (JP)

(72) Inventors: Kei Kobayashi, Hyogo (JP); Atsushi Fukui, Hyogo (JP); Taizou Sunano, Hyogo (JP); Maruo Kamino, Osaka (JP)

(73) Assignee: SANYO ELECTRIC CO., LTD., Moriguchi-city, Osaka (JP)

(21) Appl. No.: 14/344,125

(22) PCT Filed: Sep. 24, 2012
(86) PCT No.: PCT/JP2012/074384

§ 371 Date: Mar. 11, 2014

(30) Foreign Application Priority Data
Sep. 27, 2011 (JP) 2011-210286

(51) Int. Cl. H01M 10/04; H01M 4/38; H01M 4/60; H01M 10/052; H01M 2/02; H01M 4/66

(52) U.S. Cl. CPC H01M 10/0431; H01M 2/02; H01M 4/661; H01M 4/602; H01M 10/052; H01M 4/667; H01M 4/386; H01M 2/022; H01M 2/024
USPC 429/94

(57) ABSTRACT

A lithium secondary battery which is unlikely to be deformed during charging and discharging. A lithium secondary battery includes a spiral-shaped electrode assembly and a cylindrical battery container. The battery container receives the electrode assembly. The electrode assembly includes a negative electrode, a positive electrode, and a separator. The negative electrode includes a negative electrode collector and a negative electrode active material layer. The negative electrode active material layer is disposed on the negative electrode collector. The negative electrode active material layer contains a negative electrode active material forming an alloy with lithium. The positive electrode faces the negative electrode. The separator is disposed between the negative electrode and the positive electrode. When A is a proof stress of the negative electrode collector multiplied by the thickness thereof and a capacity to be charged per unit area of the negative electrode is represented by B, A≧0.075×B−3 is satisfied.

### TECHNICAL FIELD

The present invention relates to a lithium secondary battery.

### BACKGROUND ART

Heretofore, a lithium secondary battery using silicon or a silicon alloy as a negative electrode active material has been known. Silicon and a silicon alloy each exhibit a high theoretical capacity as compared that of graphite or the like. Hence, when silicon or a silicon alloy is used as a negative electrode active material, the capacity of a lithium secondary battery can be increased.

However, the change in volume of a negative electrode active material, such as silicon or a silicon alloy, which forms an alloy with lithium occurs during charging and discharging. Hence, a stress is applied to a collector during charging and discharging, and as a result, the collector may be disadvantageously deformed.

In consideration of the problem as described above, Patent Document 1 has proposed a collector which is formed of a copper alloy having a tensile strength of 400 N/mm² or more, a proportional limit of 160 N/mm² or more, and an elastic modulus of 1.1 N/mm² or more, and which has a surface roughness Ra in a range of 0.01 to 1 μm.

### CITATION LIST

### Patent Literature

Patent Document 1: Japanese Published Unexamined Patent Application No. 2003-7305

### SUMMARY OF INVENTION

### Technical Problem

When the collector disclosed in Patent Document 1 is used, a lithium secondary battery may be deformed in some cases during charging and discharging.

A primary object of the present invention is to provide a lithium secondary battery which is unlikely to be deformed during charging and discharging.

### Solution to Problem

A lithium secondary battery of the present invention includes a spiral-shaped electrode assembly and a cylindrical battery container. The battery container receives the electrode assembly. The electrode assembly includes a negative electrode, a positive electrode, and a separator. The negative electrode includes a negative electrode collector and a negative electrode active material layer. The negative electrode active material layer is disposed on the negative electrode collector. The negative electrode active material layer contains a negative electrode active material which forms an alloy with lithium. The positive electrode faces the negative electrode. The separator is disposed between the negative electrode and the positive electrode. When a value obtained by multiplying a proof stress of the negative electrode collector and the thickness thereof is represented by A, and a capacity to be charged per unit area of the negative electrode is represented by B, A≧0.075×B−3 is satisfied.

### Advantageous Effects of Invention

According to the present invention, a lithium secondary battery which is unlikely to be deformed during charging and discharging can be provided.

### BRIEF DESCRIPTION OF DRAWINGS

FIG. 1 is a schematic cross-sectional view of a lithium secondary battery according to one embodiment of the present invention.

FIG. 2 is a schematic cross-sectional view of a negative electrode according to one embodiment of the present invention.

FIG. 3 is a lateral radiograph showing a part of a lithium secondary battery formed in Experimental Example 11 taken after a charge and discharge test.

FIG. 4 is a lateral radiograph showing a part of a lithium secondary battery formed in Experimental Example 12 taken after a charge and discharge test.

FIG. 5 is a graph showing the relationship between a capacity to be charged per unit area of a negative electrode of each of Experimental Examples 1 to 14 and the product (proof stress×thickness) of the proof stress and the thickness of a negative electrode collector.

FIG. 6 is a graph showing the relationship between the rate of change in proof stress and the content of Cu in the surface of a negative electrode collector of each Experimental Examples 15 to 19.

FIG. 7 is a cross-sectional photo showing a part of a negative electrode of Experimental Example 20.

FIG. 8 is a cross-sectional photo showing a part of a negative electrode of Experimental Example 22.

FIG. 9 is a view showing the relationship between the strain and the stress for illustrating the yield elongation rate.

FIG. 10 is a graph showing the relationship between a NiCo amount of a coating layer of a negative electrode collector of each of Experimental Examples 27 to 32 and an available rate of welding obtained when a collector [Ni] is welded.

FIG. 11 is a graph showing the relationship between a NiCo amount of a coating layer of a negative electrode collector of each of Experimental Examples 33 to 36 and an initial discharge capacity of a lithium secondary battery.

### DESCRIPTION OF EMBODIMENT

Hereinafter, one example of a preferable embodiment of the present invention will be described. However, the following embodiment will be merely described by way of example. The present invention is not limited at all to the following embodiment.

The drawings referred in the embodiment and the like are schematically drawn, and for example, the ratio in dimension of a constituent drawn in the drawing may be different, for example, from the ratio in dimension of an actual constituent in some cases. In addition, between the drawings, for example, the ratio in dimension of a constituent may be changed in some cases. The dimensional ratio and the like of a concrete constituent may be appropriately judged in consideration of the following description.

### First Embodiment

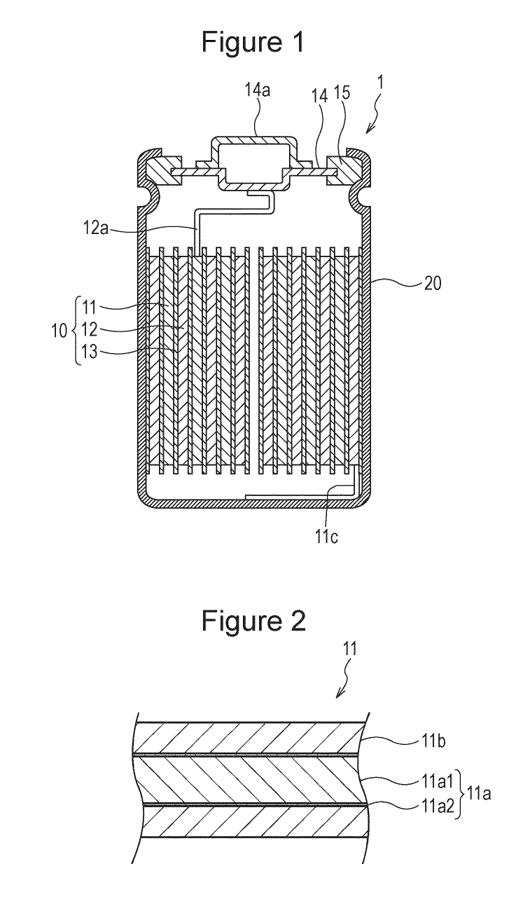

As shown in FIG. 1, a lithium secondary battery 1 is a cylindrical type secondary battery. The lithium secondary battery 1 includes a spiral-shaped electrode assembly 10 and a battery container 20. Since the battery container 20 has a cylindrical shape, a biasing force of the battery container 20 applied to the electrode assembly 10 in a radius direction is not likely to be concentrated on one portion but is uniformed, and hence, wrinkles and deflections are unlikely to be generated in a negative electrode 11 and a positive electrode 12. That is, when a negative electrode collector 11a is not able to withstand a stress generated in association with the change in volume of a negative electrode active material, the negative electrode 11 is not deformed to have an undulated shape in a thickness direction thereof but tends to extend straight along a direction parallel to the surface of the negative electrode 11. In addition, when the battery container 20 has a shape, such as a flat shape, other than a cylindrical shape, wrinkles and deflections are liable to be generated in the negative electrode 11 and the positive electrode 12, and hence, a strength required for the negative electrode collector 11a to suppress the deformation of the battery is different from that of the present invention.

(Electrode Assembly 10)

The electrode assembly 10 includes the negative electrode 11, the positive electrode 12, and a separator 13. The negative electrode 11 and the positive electrode 12 face each other. The separator 13 is disposed between the negative electrode 11 and the positive electrode 12. The negative electrode 11 and the positive electrode 12 are separated from each other by this separator 13. The electrode assembly 10 is wound to form a spiral shape. That is, the electrode assembly 10 is formed by winding a laminate in which the negative electrode 11, the separator 13, and the positive electrode 12 are laminated in this order. Hence, the electrode assembly 10 has an approximately columnar shape.

(Nonaqueous Electrolyte)

The electrode assembly 10 is impregnated with a nonaqueous electrolyte. As the nonaqueous electrolyte, for example, a known nonaqueous electrolyte may be used. In particular, as the nonaqueous electrolyte, for example, a solution may be used in which lithium hexafluoro phosphate (LiPF₆) is dissolved in a solvent, such as fluoroethylene carbonate (FEC), which is a cyclic carbonate, or methyl ethyl carbonate (MEC), which is a chain carbonate.

(Battery Container)

The electrode assembly 10 is received in a cylindrical battery container 20 provided with a bottom. A material forming the battery container 20 is not particularly limited. The battery container 20 may be formed, for example, from a metal or an alloy.

(Negative Electrode 11)

As shown in FIG. 2, the negative electrode 11 includes the negative electrode collector 11a and a negative electrode active material layer 11b. The negative electrode collector 11a may be formed, for example, of foil formed from a metal, such as copper, or an alloy containing a metal, such as copper. The negative electrode collector 11a preferably contains Cu as a primary component. In this embodiment, the “contains something as a primary component” indicates that something is contained at a rate of 50 atomic percent or more.

The negative electrode collector 11a is preferably formed of copper foil or copper alloy foil. In this case, the yield elongation rate thereof is preferably 0.24% or more, more preferably 0.26% or more, and even more preferably 0.29% or more.

The content of Cu in the surface of the negative electrode collector 11a is preferably 80 atomic percent or less and more preferably 30 atomic percent or less.

In this case, the surface of the negative electrode collector 11a indicates a region from the surface to a depth of 10 nm therefrom.

The negative electrode collector 11a may include a collector body 11a1 and a coating layer 11a2 provided on at least one primary surface of the collector body 11a1. As in this embodiment, when the negative electrode active material layers 11b are disposed on two sides of the negative electrode collector 11a, the coating layers 11a2 are preferably provided on the two primary surfaces of the collector body 11a1. The content of Cu in the coating layer 11a2 is preferably 80 atomic percent or less and more preferably 30 atomic percent or less.

Although the coating layer 11a2 may entirely cover each primary surface of the collector body 11a1, the rate of the area of the coating layer 11a2 to that of each primary surface of the collector body 11a1 is preferably 95% or less. In this case, an adhesion strength between the negative electrode collector 11a and the negative electrode active material layer 11b can be further increased. However, when the rate of the area of the coating layer 11a2 to that of each primary surface of the collector body 11a1 is excessively small, if the temperature of the negative electrode collector 11a is increased, for example, during the formation of the negative electrode 11, a decrease in proof stress of the negative electrode collector 11a may not be sufficiently suppressed in some cases. The reason for this is that oxygen may be diffused in some cases to Cu present inside the collector body 11a1 through Cu present in part of the surface of the collector body 11a1 which is not covered with the coating layer 11a2. Hence, the rate of the area of the coating layer 11a2 to that of each primary surface of the collector body 11a1 is preferably 50% or more.

The coating layer 11a2 may be a coating layer formed of NiCo. In this case, a NiCo amount of the coating layer is preferably 32 μg/cm² or more. When the NiCo amount of the coating layer is 32 μg/cm² or more, if a collector tab is welded, welding may be performed in a preferable state. The upper limit of the NiCo amount of the coating layer is preferably 100 μg/cm² or less in view of productivity and is more preferably 60 μg/cm² or less.

In addition, a coating covering rate of the coating layer formed of NiCo is preferably 95% or less, more preferably 90% or less, and even more preferably 87% or less. The lower limit of the coating covering rate is 50% or more.

When the coating covering rate is 95% or less, an initial discharge capacity of the lithium secondary battery can be increased.

The thickness of the negative electrode collector 11a is preferably, for example, approximately 6 to 50 μm and more preferably 8 to 25 μm.

The negative electrode active material layer 11b is disposed on at least one primary surface of the negative electrode collector 11a. In particular, in this embodiment, the negative electrode active material layers 11b are disposed on the two primary surfaces of the negative electrode collector 11a. The thickness of each negative electrode active material layer 11b is preferably 10 to 40 μm and more preferably 15 to 25 μm.

The negative electrode active material layer 11b contains a negative electrode active material forming an alloy with lithium. The negative electrode active material layer 11b may also contain, for example, an appropriate binder and/or an appropriate conductive agent besides the negative electrode active material. The negative electrode active material layer 11b preferably contains, for example, a polyimide resin as a binder. A polyimide resin has a high adhesion strength to a member formed of Cu or a copper alloy. Hence, when the negative electrode active material layer 11b contains a polyimide resin, an adhesion strength between the negative electrode active material layer 11b and the negative electrode collector 11a can be increased. When the adhesion strength between the negative electrode active material layer 11b and the negative electrode collector 11a is insufficient, the negative electrode active material layer is peeled away from the negative electrode collector due to the change in volume of the negative electrode active material in association with charging and discharging, and as a result, a charge and discharge capacity of the lithium secondary battery may be decreased in some cases. As in this embodiment, when the adhesion strength between the negative electrode active material layer 11b and the negative electrode collector 11a is sufficiently increased, for example, by the use of a binder including a polyimide resin, the peeling of the negative electrode active material layer 11b from the negative electrode collector 11a is suppressed, and as a result, a decrease in charge and discharge capacity of the lithium secondary battery 1 can be prevented. On the other hand, when the adhesion strength between the negative electrode active material layer 11b and the negative electrode collector 11a is high, and the negative electrode active material layer 11b is not peeled away from the negative electrode collector 11a, among stresses generated in association with the change in volume of the negative electrode active material, besides a stress in a thickness direction, a stress in a surface direction is transmitted to the negative electrode collector 11a through an adhesion surface between the negative electrode collector 11a and the negative electrode active material layer 11b. Hence, as a result, the deformation of the battery in association with charging and discharging is liable to occur as compared to that of a battery in which a negative electrode active material layer is partially or entirely peeled away from a negative electrode collector, and a strength of the negative electrode collector which is required to suppress the deformation described above tends to be increased.

As a negative electrode active material which is preferably used and which forms an alloy with lithium, for example, at least one type of metal selected from the group consisting of silicon, germanium, tin, and aluminum or an alloy including at least one type of metal selected from the group consisting of silicon, germanium, tin, and aluminum may be mentioned. Among those mentioned above, since the capacity of the lithium secondary battery 1 can be further increased, at least one of silicon and a silicon alloy is more preferably used as the negative electrode active material which forms an alloy with lithium. That is, the negative electrode active material preferably includes silicon.

(Positive Electrode 12)

The positive electrode 12 includes a positive electrode collector and a positive electrode active material layer. The positive electrode collector may be formed, for example, from a metal, such as Al, or an alloy including a metal, such as Al.

The positive electrode active material layer is provided on at least one primary surface of the positive electrode collector. The positive electrode active material layer contains a positive electrode active material. As a particular example of a preferably used positive electrode active material, for example, a lithium cobalt composite oxide, such as lithium cobalate (LiCoO₂), may be mentioned. Besides the positive electrode active material, the positive electrode active material layer may also contain an appropriate binder and/or conductive agent.

(Separator 13)

The separator 13 may be formed, for example, of a known separator. In particular, the separator 13 may be formed, for example, of a resin-made porous film. As a particular example of the resin-made porous film, for example, a polyethylene-made microporous film or a polypropylene-made microporous film may be mentioned.

In the lithium secondary battery 1,

when a value obtained by multiplying the proof stress of the negative electrode collector 11a and the thickness thereof is represented by A, and

when the capacity to be charged per unit area of the negative electrode 11 is represented by B,

A≧0.075×B-3

is satisfied. Hence, the lithium secondary battery 1 is unlikely to be deformed during charging and discharging. However, to increase A indicates to increase one of the proof stress and the thickness of the negative electrode collector or to increase both of them. In general, it has been known that when the proof stress of copper or copper alloy foil is increased, the conductivity and the breakage elongation rate tend to decrease. Hence, when copper foil or copper alloy foil is used for the negative electrode collector, if the proof stress is excessively increased, the battery capacity may be decreased in some cases due to the decrease in conductivity, and/or handling of the negative electrode collector and the negative electrode in a battery manufacturing process may become difficult in some cases due to the decrease in breakage elongation rate. In addition, when the thickness of the negative electrode collector is excessively increased, since the ratio of the negative electrode active material and that of the positive electrode active material in the battery are decreased, the battery capacity is decreased, and as a result, the merit of a high capacity of silicone or the like may not be sufficiently obtained in some cases. Hence, the lithium secondary battery 1 more preferably satisfies

A≦0.075×B-0.5

and even more preferably satisfies

A≦0.075×B-1.5.

In this case, the above disadvantages caused by the increase in proof stress and thickness of the negative electrode collector 11a are minimized, and hence, the lithium secondary battery 1 can be efficiently suppressed from being deformed.

In addition, in the present invention, the “proof stress” indicates σ_{ε} (1%) measured by the total elongation method of JIS Z 2241.

Incidentally, as the negative electrode collector 11a, Cu or a Cu alloy has been widely used. The present inventors discovered that when the negative electrode collector 11a contains Cu as a primary component, and the content of Cu in the surface of the negative electrode collector 11a is high, if the negative electrode active material layer 11b contains a polyimide resin or the like, and the negative electrode collector 11a is processed by a heat treatment during the formation of the negative electrode 11, the proof stress of the negative electrode collector 11a is decreased. In addition, the present inventors also discovered that when a heat treatment at a temperature of 250° C. or more is performed on the negative electrode collector 11a, in particular, the proof stress thereof is remarkably decreased.

In this embodiment, the content of Cu in the surface of the negative electrode collector 11a is set to 80 atomic percent or less. Hence, even if the temperature of the negative electrode collector 11a is increased, for example, during the formation of the negative electrode 11, the proof stress of the negative electrode collector 11a is unlikely to decrease. Accordingly, a negative electrode collector 11a having a higher proof stress may also be obtained. As a result, the deformation of the lithium secondary battery 1 in association with charging and discharging thereof can be more effectively suppressed. In order to more effectively suppress the deformation of the lithium secondary battery 1 in association with charging and discharging thereof, the content of Cu in the surface of the negative electrode collector 11a is preferably 30 atomic percent or less.

In addition, the reason when the content of Cu in the surface of the negative electrode collector 11a is high, the proof stress of the negative electrode collector 11a is decreased in association with a heat treatment is believed as follows. That is, since oxygen is liable to be diffused even to Cu present inside the negative electrode collector 11a through Cu present in the surface thereof, the Cu present in the surface of the negative electrode collector 11a is not only oxidized but the Cu present inside the negative electrode collector 11a is also oxidized.

In addition, when the rate of the area of the coating layer 11a2 to that of each primary surface of the collector body 11a1 is 95% or less, an initial efficiency and a capacity maintenance rate of the lithium secondary battery 1 can be increased. The reason for this is believed that when the rate of the area of the coating layer 11a2 to that of each primary surface of the collector body 11a1 is set to 95% or less, the adhesion strength between the negative electrode collector 11a and the negative electrode active material layer 11b can be increased. In order to further increase the initial efficiency and the capacity maintenance rate of the lithium secondary battery 1, the rate of the area of the coating layer 11a2 to that of each primary surface of the collector body 11a1 is preferably 93% or less.

Hereinafter, although being described in more detail with reference to particular Experimental Examples, the present invention is not limited at all to the following Experimental Examples and may be appropriately changed and modified without departing from the scope of the present invention.

### Experimental Example 1

By the use of a negative electrode, a positive electrode, a nonaqueous electrolyte, and a cylindrical type battery container formed as described below, a cylindrical lithium secondary battery 1 having a diameter of 18 mm and a height of 65.0 mm was formed.

[Formation of Negative Electrode 11]

First, a negative electrode active material was formed as described below. A silicon core placed in a reducing furnace was heated to 800° C. by current application, and a mixed gas of a monosilane SiH₄ gas and a hydrogen gas, each of which had a high purity, was allowed to flow in the furnace to deposit polycrystalline silicon on the surface of the silicon core, thereby forming a polycrystalline silicon ingot. Next, this polycrystalline silicon ingot was pulverized and classified, so that a negative electrode active material formed of polycrystalline silicon particles having a purity of 99% was obtained. The crystallite size of the negative electrode active material was 32 nm. The average particle diameter of the negative electrode active material was 10 μm. In addition, the crystallite size was calculated by the scherrer equation using the half width of the peak of the (111) plane of silicon obtained by powder x-ray diffraction. In addition, the average particle diameter was obtained by a laser diffraction method.

Next, the negative electrode active material formed as described above, a graphite powder (conductive agent) having an average particle diameter of 3.5 μm, and a vanish which was a precursor of a thermoplastic polyimide resin (binder) having a glass transition temperature of approximately 300° C. and a weight average molecular weight of approximately 50,000 were added to N-methyl-2-pyrollidone (dispersion medium) and then mixed together, thereby forming a negative electrode mixture slurry. In Experimental Example 1, the mass ratio of the negative electrode active material, the graphite powder, and the thermoplastic polyimide resin was set to 100:3:8.6.

Next, two facing surfaces of copper foil having the thickness and the proof stress shown in Table 1 were roughened by electrolytic copper plating, so that the negative electrode collector 11a was obtained. The roughness of the roughened copper foil represented by Ra was 0.2 μm. In addition, the mean spacing of the local peaks S on the surface of the roughened copper foil was 0.9 μm.

Next, the negative electrode mixture slurry was applied to two facing surfaces of the negative electrode collector 11a at 25° C. in the air and was then dried at 120° C. in the air. Subsequently, after rolling was performed at 25° C. in the air, a heat treatment was performed at the temperature shown in Table 1 for 10 hours in an argon atmosphere, so that the negative electrode active material layer 11b was formed on each of the two facing surfaces of the negative electrode collector 11a.

Next, the negative electrode collector 11a provided with the negative electrode active material layer 11b on each of the two facing surfaces thereof was cut into a belt shape having a width of 58.6 mm, and a negative electrode collector tab 11c formed from nickel was fitted to the collector 11a thus cut, so that the negative electrode 11 was formed.

[Formation of Positive Electrode 12]

First, a positive electrode active material was formed as described below. After Li₂CO₃ and CoCO₃ were mixed together using a mortar so that the molar ratio (Li:Co) of Li and Co was set to 1:1 and were processed by a heat treatment at 800° C. for 24 hours in an air atmosphere, pulverization was performed. As a result, a powder of lithium cobalate represented by LiCoO₂ and having an average particle diameter of 11 μm was obtained. This lithium cobalate powder was used as the positive electrode active material. In addition, a BET specific surface area of the positive electrode active material was 0.37 m²/g.

Next, the positive electrode active material, a carbon material powder (conductive agent) having an average particle diameter of 2 μm, and a poly(vinylidene fluoride) (binder) were added to N-methyl-2-pyrollidone functioning as a dispersion medium so as to have a mass ratio of 95:2.5:2.5 and were the kneaded together, thereby preparing a positive electrode mixture slurry.

Next, after the positive electrode mixture slurry was applied to two facing surfaces of a positive electrode collector formed of aluminum foil having a thickness of 15 μm so as to have the application quantity per unit area shown in Table 1 and was then dried, rolling was performed. Subsequently, after a belt shape having a width of 56.8 mm was obtained by cutting the above coated collector, an aluminum-made positive electrode collector tab 12a was fitted thereto, thereby forming the positive electrode 12.

[Formation of Nonaqueous Electrolyte]

In a mixed solvent in which 4-fluoroethylene carbonate (FEC) and ethyl methyl carbonate (EMC) were mixed at a volume ratio of 2:8, lithium hexafluoro phosphate LiPF₆ was dissolved to have a concentration of 1.0 mol/l. In addition, a carbon dioxide gas at a concentration of 0.4 percent by weight was added to the solution thus formed to form a nonaqueous electrolyte.

[Formation of Battery]

The positive electrode 12 and the negative electrode 11, each of which was formed as described above, were disposed to face each other with the separator 13 provided therebetween, the separator 13 being formed of a lithium ion-permeable polyethylene-made microporous film, thereby forming a laminate. After this laminate was wound around a winding core having an outside diameter of 4 mm, the winding core was removed from the wound laminate to form the electrode assembly 10. Incidentally, only the negative electrode 11 and the separator 13 were first wound one turn, and the positive electrode 12 was then wound together therewith. Accordingly, at an inner circumference portion of a main portion formed of the positive electrode 12, the negative electrode 11, and the separator 13, a biasing portion was formed from the negative electrode 11 and the separator 13. Since the biasing portion uniformly biased the main portion in a radius direction, wrinkles and deflections were not easily allowed to be formed in the electrode plates.

Next, the electrode assembly 10 was received in the battery container 20. Subsequently, the positive electrode collector tab 12a was electrically connected to a positive electrode lid 14 provided with a positive electrode exterior terminal 14a, and the negative electrode collector tab 11c was also electrically connected to the battery container 20. Next, the nonaqueous electrolyte formed as described above was charged into this battery container 20, and sealing was then performed using an insulating packing 15, thereby forming the lithium secondary battery 1.

In addition, in Experiment Example 1, as shown in Table 1, a capacity B to be charged per unit volume of the negative electrode 11 was 78.7 Ah/m².

### Experimental Examples 2 to 14

Except that the application quantity of the positive electrode mixture slurry, the capacity B to be charged per unit volume of the negative electrode 11, the type, the thickness, and the proof stress of copper foil used for the formation of the negative electrode collector 11a, and the heat treatment temperature were set as shown in Table 1, a lithium secondary battery was formed in a manner similar to that in Experimental Example 1.

In addition, in Experimental Examples 2 to 4, 8, 10 to 12, and 14, in each of which zirconium copper alloy foil was used as the collector, the content of Cu in the surface of the negative electrode collector 11a was measured by integrating the element from the surface thereof to a depth of 10 nm using an XPS analysis, and the results are shown in Table 1.

[Evaluation]

The dimension in length of the lithium secondary battery formed in each of Experimental Examples 1 to 14 was measure along the axis direction thereof using a slide gage. Next, after constant current charging was performed on the lithium secondary battery at a current of 170 mA for 4 hours, constant current charging was performed at a current of 680 mA until the battery voltage reached 4.25 V, and constant voltage charging was further performed at a voltage of 4.25 V until the current reached 170 mA, so that initial charging was performed. Next, initial discharging was performed on the lithium secondary battery in such a way that constant current discharging was performed at a current of 680 mA until the battery voltage reached 3.0 V. Subsequently, the dimension in length of the lithium secondary battery was measured again along the axis direction thereof using a slide gage. The difference between the dimension in length of the lithium secondary battery before the initial charging and the initial discharging were performed and the dimension in length of the lithium secondary battery after the initial charging and the initial discharging were performed was obtained as a deformation amount. The results are shown in Table 1.

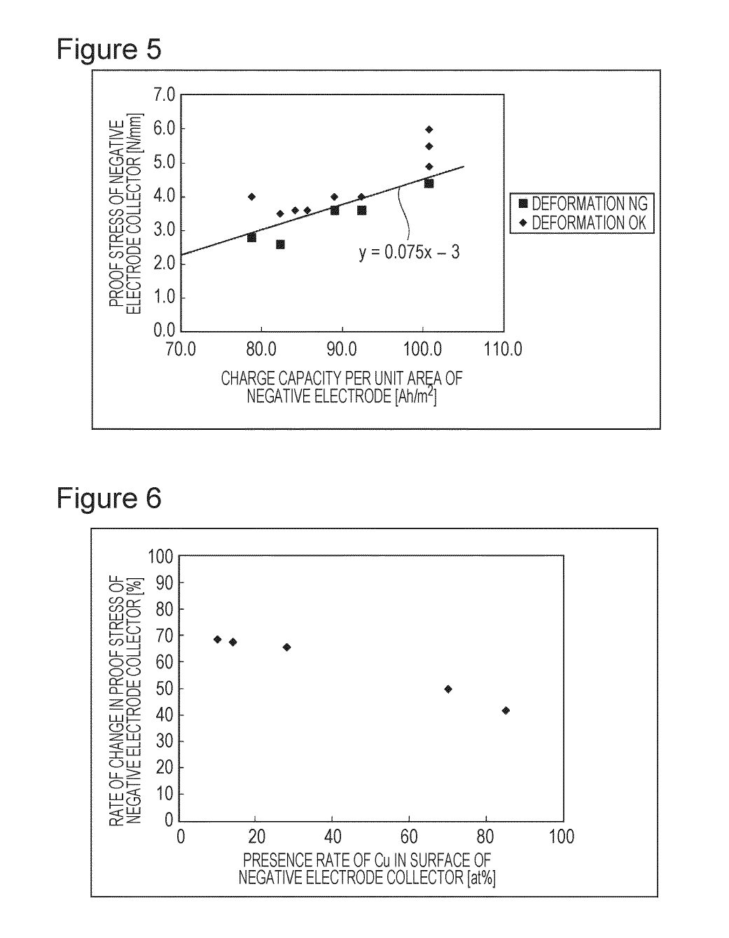

In addition, the relationship between the proof stress of the negative electrode collector and the capacity to be charged per unit area of the negative electrode of each of Experimental Examples 1 to 14 is shown in FIG. 5.

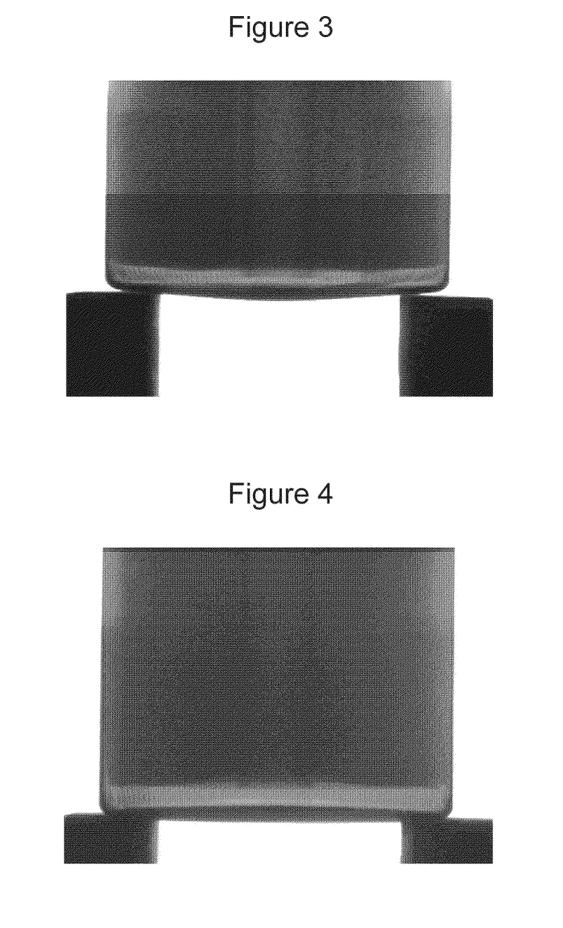

A lateral radiograph of a part of the lithium secondary battery formed in Experimental Example 11 taken after the charge and discharge test was performed is shown in FIG. 3. A lateral radiograph of a part of the lithium secondary battery formed in Experimental Example 12 taken after the charge and discharge test was performed is shown in FIG. 4.

TABLE 1

| | | | | | | | | Heat | |
|---|---|---|---|---|---|---|---|---|---|
| | | | | Proof | Proof | | Appli- | Treatment | Defor- |
| | | Content | Thickness of | Stress of | Stress × | Charge | cation | Temper- | mation |
| | Type of | of Cu | Copper Foil | Copper Foil | Thickness | Capacity | Quantity | ature | Amount |
| | Copper Foil | [%] | [μm] | [N/mm²] | A [N/mm] | B [Ah/m²] | [g/m²] | [° C.] | [mm] |
| Experimental | Electrolyte | | 12 | 233 | 2.8 | 78.7 | 480 | 400 | 0.25 |
| Example 1 | Copper Foil | | | | | | | | |
| Experimental | Zirconium | 28.0 | 13.5 | 296 | 4.0 | 78.7 | 480 | 400 | 0 |
| Example 2 | Copper Alloy | | | | | | | | |
| | Foil | | | | | | | | |
| Experimental | Zirconium | 28.0 | 13.5 | 193 | 2.6 | 82.3 | 490 | 420 | 0.64 |
| Example 3 | Copper Alloy | | | | | | | | |
| | Foil | | | | | | | | |
| Experimental | Zirconium | 28.0 | 13.5 | 259 | 3.5 | 82.3 | 490 | 410 | 0 |
| Example 4 | Copper Alloy | | | | | | | | |
| | Foil | | | | | | | | |
| Experimental | Copper Iron | | 13 | 277 | 3.6 | 84.1 | 500 | 400 | 0 |
| Example 5 | Alloy Foil | | | | | | | | |
| Experimental | Copper Iron | | 13 | 277 | 3.6 | 85.6 | 510 | 400 | 0 |
| Example 6 | Alloy Foil | | | | | | | | |
| Experimental | Copper Iron | | 13 | 277 | 3.6 | 89.0 | 530 | 400 | 0.17 |
| Example 7 | Alloy Foil | | | | | | | | |
| Experimental | Zirconium | 28.0 | 13.5 | 296 | 4.0 | 89.0 | 530 | 400 | 0 |
| Example 8 | Copper Alloy | | | | | | | | |
| | Foil | | | | | | | | |
| Experimental | Copper Iron | | 13 | 277 | 3.6 | 92.4 | 550 | 400 | 0.52 |
| Example 9 | Alloy Foil | | | | | | | | |
| Experimental | Zirconium | 28.0 | 13.5 | 296 | 4.0 | 92.4 | 550 | 400 | 0 |
| Example 10 | Copper Alloy | | | | | | | | |
| | Foil | | | | | | | | |
| Experimental | Zirconium | 85.0 | 12 | 367 | 4.4 | 100.7 | 600 | 350 | 0.52 |
| Example 11 | Copper Alloy | | | | | | | | |
| | Foil without | | | | | | | | |
| | Rust Prevention | | | | | | | | |
| | Treatment | | | | | | | | |
| Experimental | Zirconium | 28.0 | 12 | 408 | 4.9 | 100.7 | 600 | 350 | 0 |
| Example 12 | Copper Alloy | | | | | | | | |
| | Foil | | | | | | | | |
| Experimental | Copper Iron | | 13 | 462 | 6.0 | 100.7 | 600 | 300 | 0 |
| Example 13 | Alloy Foil | | | | | | | | |
| Experimental | Zirconium | 28.0 | 12 | 458 | 5.5 | 100.7 | 600 | 250 | 0 |
| Example 14 | Copper Alloy | | | | | | | | |
| | Foil | | | | | | | | |

From the results shown in Table 1 and FIGS. 3 to 5, it is found that when a negative electrode which satisfies A≧0.075×B−3 is used, the deformation of the lithium secondary battery during charging and discharging can be suppressed.

### Experimental Examples 15 to 19

After electrolytic plating of a Zn—Ni alloy was performed on a surface of zirconium copper alloy foil having a thickness of 12 μm, a chromate treatment was performed. In this case, a plating amount of the Zn—Ni alloy was set so that the content of Cu in the surface was as shown in Table 2.

Incidentally, the chromate treatment is a treatment method defined in JIZ Z 0103 and is in particular, a surface treatment method in which a metal is processed with a solution containing a chromic acid salt or a dichromic acid salt as a primary component to form a rust proof film.

A tensile test defined in JIS Z 2241 was performed on the collector thus obtained, so that the proof stress thereof was measured.

Next, a heat treatment was performed at 400° C. for 10 hours in an argon atmosphere. Subsequently, the proof stress of the collector was again measured by a method similar to that described above. From the proof stress before the heat treatment and that after the heat treatment, the rate of change in proof stress before and after the heat treatment was obtained. The results are shown in Table 2. In addition, a graph showing the relationship between the rate of change in proof stress and the content of Cu in the surface of the negative electrode collector of each of Experimental Examples 15 to 19 is shown in FIG. 6.

In addition, the content of Cu in the surface was obtained by integrating the element from the surface to a depth of 10 nm therefrom by an XPS analysis.

The contents of Cu at a depth of 100 nm of the collectors formed in Experimental Examples 15 to 19 were all 90% or more. From the results described above, it is understood that the thickness of the coating layer formed of a Zn—Ni plating layer and a chromate layer is less than 100 nm.

TABLE 2

| | | Proof Stress | Proof Stress | Rate of |
|---|---|---|---|---|
| | Content | before Heat | after Heat | Change in |
| | of Cu | Treatment | Treatment | Proof Stress |
| | [at %] | [N/mm²] | [N/mm²] | [%] |
| Experimental | 28 | 464 | 305 | 66 |
| Example 15 | | | | |
| Experimental | 14 | 465 | 315 | 68 |
| Example 16 | | | | |
| Experimental | 10 | 470 | 323 | 69 |
| Example 17 | | | | |
| Experimental | 70 | 474 | 237 | 50 |
| Example 18 | | | | |
| Experimental | 85 | 474 | 199 | 42 |
| Example 19 | | | | |

From the results shown in Table 2, it is found that when the content of Cu in the surface of the collector is set to 80 atomic percent or less, the decrease in proof stress caused by the heat treatment can be suppressed. In addition, it is also found that in order to more effectively suppress the decrease in proof stress caused by the heat treatment, the content of Cu in the surface of the collector is more preferably 70 atomic percent or less and even more preferably 30 atomic percent or less.

### Experimental Examples 20 to 23

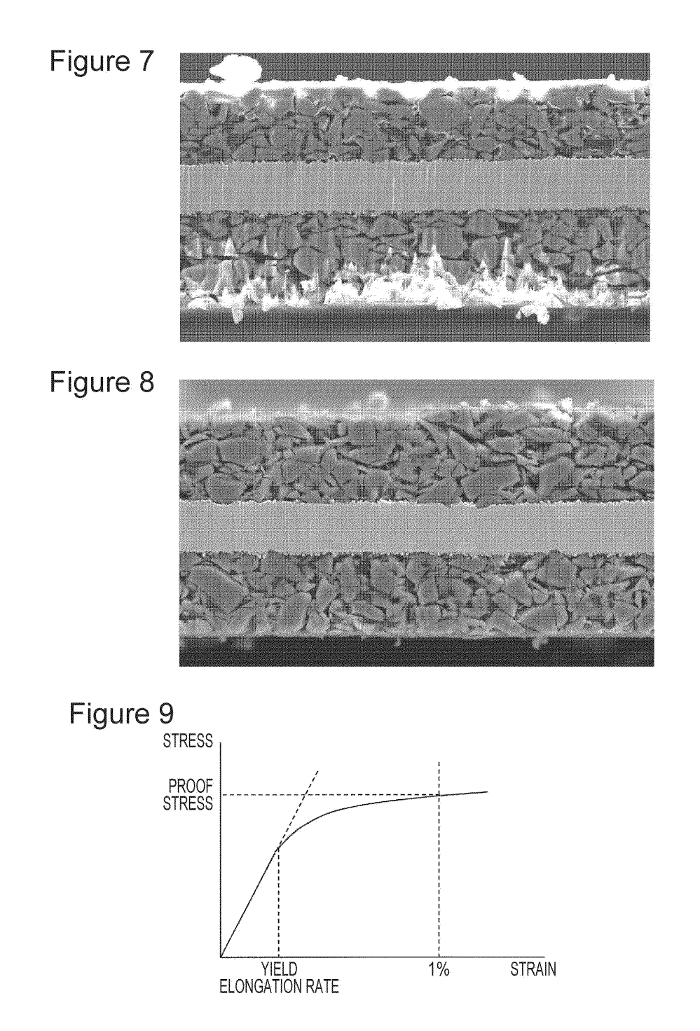

Except that the linear pressure in rolling of the negative electrode was set as shown in Table 3, a negative electrode was formed in a manner similar to that of Experimental Example 2, and in addition, a lithium secondary battery was also formed. A cross-sectional photo of a part of the negative electrode of Experimental Example 20 is shown in FIG. 7. A cross-sectional photo of a part of the negative electrode of Experimental Example 22 is shown in FIG. 8.

In each Experimental Example, after two negative electrodes were formed under the same condition, one negative electrode was used to form the lithium secondary battery, and the other negative electrode was used to measure the rate of the area of the coating layer to that of the surface of the collector body formed of zirconium copper alloy foil. In particular, cross-sectional processing was performed on the negative electrode formed in each Experimental Example using a cross-sectional polisher, and the cross-section in the vicinity of the surface of the negative electrode collector was observed using a scanning electron microscope (SEM). After a region having a length of 250 μm in a surface direction of the negative electrode collector was extracted from the cross-section thus observed as an evaluation region, the length of a part of the collector in a surface direction in which silicon particles functioning as the negative electrode active material penetrate the collector body to a depth of 100 nm or more was measured and was divided by 250 μm, which was the length of the total evaluation region, and the value obtained thereby was regarded as a coating layer covering rate.

Next, the initial efficiency and the capacity maintenance rate of the lithium secondary battery formed in each of Experimental Examples 20 to 23 were measured as described below. First, constant current charging was performed on each lithium secondary battery at a current of 170 mA for 4 hours. Subsequently, initial charging was performed in such a way that constant current charging was performed at a current of 680 mA until the battery voltage reached 4.25 V, and constant voltage charging was further performed at a voltage of 4.25 V until the current reached 170 mA.

Next, initial discharging was performed on the lithium secondary battery at a current of 680 mA until the battery voltage reached 3.0 V. In addition, the ratio of the initial discharge amount to the initial charge amount was obtained as the initial efficiency. The results are shown in Table 3. In addition, the initial efficiency shown in Table 3 was a normalized value obtained when the initial efficiency of the lithium secondary battery formed in Experimental Example 20 was assumed to be 100.

Next, charging and discharging were performed 100 cycles, in each of which after charging was performed in such a way that constant current charging was performed on the lithium secondary battery at a current of 1,700 mA until the battery voltage reached 4.25 V, and constant voltage charging was further performed at a voltage of 4.25 V until the current reached 170 mA, constant current discharging was performed at a current of 3,400 mA until the battery voltage reached 3.0 V. In addition, the ratio of the discharge capacity at a 100th cycle to the discharge capacity at a first cycle was obtained as the capacity maintenance ratio. The results are shown in Table 3. In addition, the capacity maintenance ratio shown in Table 3 was a normalized value obtained when the capacity maintenance ratio of the lithium secondary battery formed in Experimental Example 20 was assumed to be 100.

TABLE 3

| | | | | Maintenance |
|---|---|---|---|---|
| | Rolling | Coating | Initial | Ratio after |
| | Linear | Layer | Efficiency | 100 Cycles |
| | Pressure | Covering | [Normalized | [Normalized |
| | [ton/cm] | Rate [%] | Value] | Value] |
| Experimental | 0.7 | 100 | 100.0 | 100.0 |
| Example 20 | | | | |
| Experimental | 1 | 99 | 100.1 | 100.5 |
| Example 21 | | | | |
| Experimental | 2 | 93 | 100.6 | 102.3 |
| Example 22 | | | | |
| Experimental | 3 | 87 | 100.6 | 102.7 |
| Example 23 | | | | |

From the results shown in Table 3, it is found that when the rate (coating layer covering rate) of the area of the coating layer to that of the surface of the collector body is set to 95% or less, a high initial efficiency and a high capacity maintenance ratio can be obtained. In order to further increase the initial efficiency and the capacity maintenance ratio, it is found that the rate of the area of the coating layer to that of the surface of the collector body is preferably 93% or less.

### Experimental Examples 24 to 26

After a negative electrode synthetic slurry was applied on the copper foil shown in Table 4, a heat treatment was performed for 10 hours at the heat treatment temperature shown in Table 4 to form the negative electrode active material layers 11b on two facing surfaces of the negative electrode collector 11a.

A positive electrode was formed in a manner similar to that in each of Experimental Examples 1 to 14 except that the application quantity per unit area was set as shown in Table 4.

The proof stress and the yield elongation rate of each copper foil were measured in such a way that after each copper foil was processed by a heat treatment similar to that described above, the negative electrode collector thus heat-treated was used for the measurement.

FIG. 9 is a view illustrating the yield elongation rate. The yield elongation rate was measured by a tensile test method of JIS Z 2241 as in the measurement of the proof stress. As shown in FIG. 9, the relationship between the strain and the stress is first linearly changed and is then bent so that the change in stress to the change in strain is decreased. The strain (that is, the elongation rate) at this bending point corresponds to the yield elongation rate.

Charging and discharging were performed under charge and discharge conditions similar to those of Experimental Examples 1 to 14, and the deformation amount of the lithium secondary battery after charging and discharging was measured in a manner similar to that described above.

In addition, the state of the negative electrode after 20 cycles were performed was evaluated whether the electrode plate was fractured or not.

FIG. 4 shows the charge capacity B of the lithium secondary battery, the thickness and the proof stress of the copper foil, the value of proof stress×thickness, the deformation amount of the lithium secondary battery, the yield elongation rate of the negative electrode collector, and the evaluation result of the fractured state of the electrode plate after 20 cycles of the lithium secondary battery were performed.

TABLE 4

| | | | | Heat | | | | | | |
|---|---|---|---|---|---|---|---|---|---|---|
| | | | | Treatment | | Proof | Proof | Defor- | | Fracture of |
| | Application | Charge | | Temper- | Thickness of | Stress of | Stress × | mation | Yield | Electrode |
| | Quantity | Capacity | Type of | ature | Copper Foil | Copper Foil | Thickness | Amount | Elongation | Plate after |
| | [g/m²] | B [Ah/m²] | Copper Foil | [° C.] | [μm] | [N/mm²] | A [N/mm] | [mm] | Rate [%] | 20 Cycles |
| Experi- | 600 | 100.7 | Electrolyte | 350 | 13.5 | 426 | 5.8 | 0 | 0.22 | Yes |
| mental | | | Copper Foil | | | | | | | |
| Example 24 | | | | | | | | | | |
| Experi- | 600 | 100.7 | Zirconium | 350 | 13.5 | 408 | 5.5 | 0 | 0.29 | No |
| mental | | | Copper Alloy | | | | | | | |
| Example 25 | | | Foil | | | | | | | |
| Experi- | 600 | 100.7 | Copper Iron | 300 | 13 | 462 | 6.0 | 0 | 0.33 | No |
| mental | | | Alloy Foil | | | | | | | |
| Example 26 | | | | | | | | | | |

As shown in Table 4, in the lithium secondary battery of each of Experimental Examples 24 to 26, since the value A, which is the product of the proof stress and the thickness, satisfies the formula, A>0.0075×B−3, with respect to the charge capacity B per unit area, the deformation of the battery after the initial charging and discharging is suppressed.

However, in Experimental Example 24, the electrode plate (negative electrode) was fractured after 20 cycles. The reason for this is believed that since the negative electrode collector has a predetermined proof stress or more, although the deformation amount of the electrode plate per cycle can be suppressed, since the yield elongation rate of the negative electrode collector is less than 0.26%, the deformation of the electrode plate reaches a plastic deformation region. Hence, it is believed that when the charging and discharging are repeatedly performed, the plastic elongation is accumulated, and as a result, the electrode plate is fractured within a predetermined number of cycles.

On the other hand, in Experimental Examples 25 and 26, the electrode plate was not fractured even after 20 cycles were performed. The reason for this is believed that since the yield elongation rate is 0.26% or more, the deformation of the electrode plate is within an elastic region, and even if charging and discharging are repeatedly performed, since the elongation deformation is not accumulated, the electrode plate is not fractured even after 20 cycles were performed.

### Experimental Examples 27 to 36

Electroplating of a Ni—Co alloy was performed on the surface of the above zirconium copper alloy foil (thickness: 13.5 μm). As a plating solution, a plating solution containing 175 g/L of nickel sulfate, 25 g/L of cobalt sulfate, and 30 g/L of sodium citric acid, and having a pH of 3 and a solution temperature of 40° C. was used.

The current density was set to 4.5 A/dm², and the plating time was set as shown in Table 5 to control the plating amount (NiCo amount), so that a negative electrode collector of each of Experimental Examples 27 to 36 was formed.

The Ni amount, the Co amount, and the total amount thereof, that is, the NiCo amount, of the coating layer of the negative electrode collector are shown in Table 5. The Ni amount and the Co amount were each measured by a fluorescent x-ray analytical apparatus.

TABLE 5

| | | Ni Amount | Co Amount | NiCo Amount |
|---|---|---|---|---|
| | | on Surface | on Surface | on Surface |
| | | of Copper | of Copper | of Copper |
| | Plating | Foil | Foil | Foil |
| | Time | [μg/cm²] | [μg/cm²] | [μg/cm²] |
| Experimental | 4 | 8 | 9 | 17 |
| Example 27 | | | | |
| Experimental | 5.5 | 11 | 12 | 23 |
| Example 28 | | | | |
| Experimental | 7.5 | 16 | 15 | 31 |
| Example 29, | | | | |
| 33, 34 | | | | |
| Experimental | 8 | 17 | 16 | 33 |
| Example 30 | | | | |
| Experimental | 9.5 | 21 | 18 | 39 |
| Example 31 | | | | |
| Experimental | 11 | 25 | 19 | 44 |
| Example 32, | | | | |
| 35, 36 | | | | |

### Experimental Examples 27 to 32

A nickel tab functioning as a collector tab was welded to the negative electrode collector obtained in each of Experimental Examples 27 to 32 by ultrasonic welding. After the welding, when the nickel tab was peeled off from the collector, a cell in which peeling was performed along the interface of the welding was ranked as “NG”, a cell in which the copper alloy foil, which was the negative electrode collector, was fractured was ranked as “Good”, and the rate of the number of the cells ranked as “Good” to 100 cells thus evaluated was shown in Table 6 as “Available Rate of Welding”.

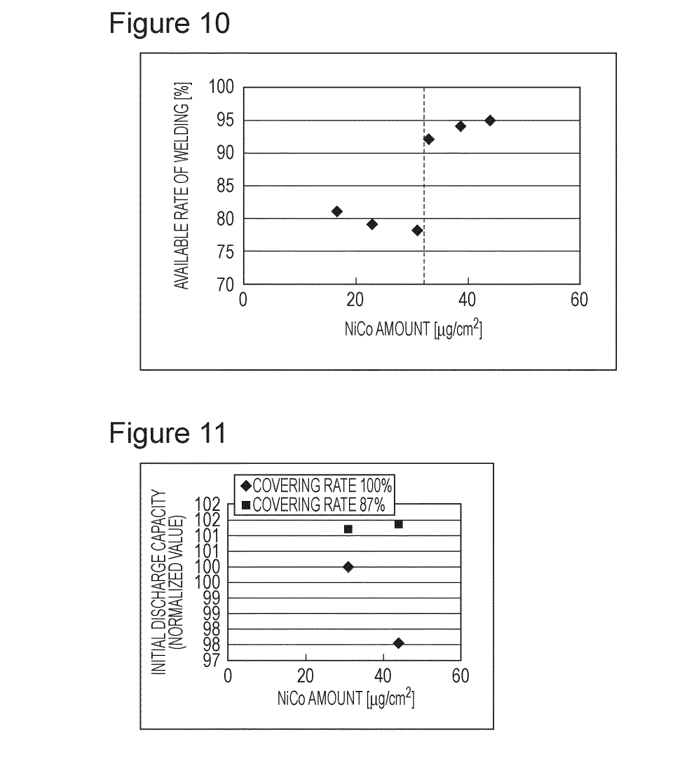

In addition, the relationship between the NiCo amount and the available rate of welding is shown in FIG. 10.

TABLE 6

| | Ni Amount | Co Amount | NiCo Amount | |
|---|---|---|---|---|
| | on Surface | on Surface | on Surface | Available |
| | of Copper | of Copper | of Copper | Rate of |
| | Foil | Foil | Foil | Welding |
| | [μg/cm²] | [μg/cm²] | [μg/cm²] | [%] |
| Experimental | 8 | 9 | 17 | 81 |
| Example 27 | | | | |
| Experimental | 11 | 12 | 23 | 79 |
| Example 28 | | | | |
| Experimental | 16 | 15 | 31 | 78 |
| Example 29 | | | | |
| Experimental | 17 | 16 | 33 | 92 |
| Example 30 | | | | |
| Experimental | 21 | 18 | 39 | 94 |
| Example 31 | | | | |
| Experimental | 25 | 19 | 44 | 95 |
| Example 32 | | | | |

As apparent from Table 6 and FIG. 10, it is found that when the NiCo amount is 32 μg/cm² or more, the welding properties are improved.

### Experimental Examples 33 to 36

As in Experimental Examples 20 to 23, a negative electrode was formed by applying a negative electrode mixture slurry on a negative electrode collector, and by the use of the negative electrode thus obtained, a lithium secondary battery was formed.

In Experimental Examples 33 and 34 and Experimental Examples 35 and 36, as in Experimental Examples 20 to 23, by changing the linear pressure in rolling of the negative electrode, a negative electrode having a coating covering rate of 100% was formed in each of Experimental Examples 33 and 35, and a negative electrode having a coating covering rate of 87% was formed in each of Experimental Examples 34 and 36. In addition, the coating covering rate was measured in a manner similar to that in each of Experimental Examples 20 to 23.

A test similar to that in Experimental Example 10 was performed, so that the initial discharge capacity was measured.

The coating covering rate and the initial discharge capacity are shown in Table 7. In addition, the initial discharge capacity shown in Table 7 is a normalized value obtained when the initial discharge capacity of Experimental Example 33 is assumed to be 100.

In addition, in FIG. 11, the relationship between the NiCo amount and the initial discharge capacity is shown.

TABLE 7

| | Ni Amount on | Co Amount | NiCo Amount | | Initial Discharge |
|---|---|---|---|---|---|
| | Surface of | on Surface of | on Surface of | Coating | Capacity |
| | Copper Foil | Copper Foil | Copper Foil | Covering | (Normalized |
| | [μg/cm²] | [μg/cm²] | [μg/cm²] | Rate [%] | Value) |
| Experimental | 16 | 15 | 31 | 100 | 100 |
| Example 33 | | | | | |
| Experimental | 16 | 15 | 31 | 87 | 101 |
| Example 34 | | | | | |
| Experimental | 25 | 19 | 44 | 100 | 98 |
| Example 35 | | | | | |
| Experimental | 25 | 19 | 44 | 87 | 101 |
| Example 36 | | | | | |

As apparent from Table 7 and FIG. 11, it is found that when the coating covering rate is 100%, if the NiCo amount is large, the initial discharge capacity is decreased. In addition, it is found that when the coating covering rate is 95% or less, the initial discharge capacity is excellent. In addition, it is also found that the degree thereof is improved as the NiCo amount is increased.

### REFERENCE SIGNS LIST

1 lithium secondary battery
10 electrode assembly
11 negative electrode
11a negative electrode collector
11a1 collector body
   11a2 coating layer
   11b negative electrode active material layer
   11c negative electrode collector tab
   12 positive electrode
   12a positive electrode collector tab
   13 separator
   14 positive electrode lid
   14a positive electrode exterior terminal
   15 insulating packing
   20 battery container

1. A lithium secondary battery comprising:
a spiral-shaped electrode assembly; and
a cylindrical battery container receiving the electrode assembly,
wherein the electrode assembly includes:
a negative electrode including a negative electrode collector and a negative electrode active material layer which is disposed on the negative electrode collector and which contains a negative electrode active material forming an alloy with lithium:
a positive electrode facing the negative electrode; and
a separator disposed between the negative electrode and the positive electrode, and
when a value obtained by multiplying a proof stress of the negative electrode collector and the thickness thereof is represented by A, and a capacity to be charged per unit area of the negative electrode is represented by B,
A≧0.075×B−3 is satisfied.

2. The lithium secondary battery according to claim 1,
wherein the negative electrode collector includes copper foil or copper alloy foil, and the yield elongation rate thereof is 0.24% or more.

3. The lithium secondary battery according to claim 2,
wherein the copper foil or the copper alloy foil is rolled foil.

4. The lithium secondary battery according to claim 1,
wherein the negative electrode active material layer further contains a polyimide resin,
the negative electrode collector contains Cu as a primary component, and
the content of Cu in a surface of the negative electrode collector is 80 atomic percent or less.

5. The lithium secondary battery according to claim 4,
wherein the content of Cu in the surface of the negative electrode collector is 30 atomic percent or less.

6. The lithium secondary battery according to claim 4,
wherein the negative electrode collector includes:
a collector body; and
a coating layer which is disposed on one primary surface of the collector body and which has a content of Cu of 80 atomic percent or less, and
the rate of the area of the coating layer to that of the one primary surface of the collector body is 95% or less.

7. The lithium secondary battery according to claim 1,
wherein the negative electrode collector includes:
a collector body; and
a coating layer which is disposed on one primary surface of the collector body and which is formed from NiCo.

8. The lithium secondary battery according to claim 7,
wherein the amount of NiCo of the coating layer is 32 μg/cm² or more.

9. The lithium secondary battery according to claim 1,
wherein the negative electrode active material includes silicon.

10. The lithium secondary battery according to claim 5,
wherein the negative electrode collector includes:
a collector body; and
a coating layer which is disposed on one primary surface of the collector body and which has a content of Cu of 80 atomic percent or less, and
the rate of the area of the coating layer to that of the one primary surface of the collector body is 95% or less.
